(19) United States
(12) Patent Application Publication
(10) Pub. No.: US 2025/0281833 A1
(43) Pub. Date: Sep. 11, 2025

(54) METHOD FOR INTERACTION OF DEVICES IN VIRTUAL SCENE AND RELATED PRODUCT

(71) Applicant: NANJING OPPO SOFTWARE TECHNOLOGY CORP., LTD., Nanjing (CN)

(72) Inventor: Fenghua HUANG, Dongguan (CN)

(21) Appl. No.: 19/219,321

(22) Filed: May 27, 2025

Related U.S. Application Data
(63) Continuation of application No. PCT/CN2023/122791, filed on Sep. 28, 2023.

(30) Foreign Application Priority Data
Dec. 23, 2022 (CN) 202211670557.7

(51) Int. Cl. A63F 13/52

(52) U.S. Cl. CPC A63F 13/52; A63F 2300/8082

(57) ABSTRACT

Embodiments of the disclosure provide a method for device interaction in virtual scene and a related product. The virtual scene is created. The virtual scene entry request sent by each the second device is received, and the virtual object corresponding to the at least one second device that enters the virtual scene is determined, where the virtual scene entry request includes the virtual object corresponding to the second device. The anchor location for each virtual object in the virtual scene is determined, and the virtual object corresponding to each second device is displayed at the anchor location. The pose data and the expression data sent by each of the at least one second device is received, and the virtual object is controlled to display the expression indicated by the expression data and the pose indicated by the pose data.

This application is a continuation of International Application No. PCT/CN2023/122791 filed Sep. 28, 2023, which claims priority to Chinese Patent Application No. 202211670557.7, filed Dec. 23, 2022, and the entire disclosures of the above-identified applications are incorporated herein by reference.

### TECHNICAL FIELD

The disclosure relates to the technical field of electronic devices, and in particular to a method for device interaction in virtual scene and a related product.

### BACKGROUND

Virtual conference refers to construction of a complete online virtual conference room through 3D modeling, and users can participate in a virtual conference through a handheld electronic device. Simultaneous localization and mapping (SLAM) technology may be used in a virtual conference application to achieve virtual object tracking and map construction, and constructed map and character model may be drawn in a virtual scene; in addition, combined with human posture detection, the character model is driven to achieve actions such as walking and sitting.

At present, the SLAM technology needs to strongly rely on visual algorithms and high-precision inertial measurement units (IMUs), otherwise, an incoherence of the driven character model occurs. In addition, the user is required to hold the electronic device all the time, which results in a poor user experience.

### SUMMARY

Embodiments of the disclosure provide a method for device interaction in virtual scene and a related product.

In a first aspect, the embodiments of the disclosure provide a method for device interaction in a virtual scene, where the method is implemented by a first device, the first device is in a communication connection with at least one second device, and the method includes:
creating a virtual scene;
receiving a virtual scene entry request sent by each of the at least one second device, and determining, based on the virtual scene entry request, a virtual object corresponding to each of the at least one second device that enters the virtual scene, where the virtual scene entry request sent by each second device includes the virtual object corresponding to the second device;
determining an anchor location for each virtual object in the virtual scene, and displaying the virtual object corresponding to each of the at least one second device at the respective anchor location, where the anchor location for each virtual object is configured to determine a relative position of the virtual object in the virtual scene; and
receiving pose data and expression data sent by each of the at least one second device, and controlling the virtual object to display an expression indicated by the expression data and a pose indicated by the pose data.

In a second aspect, the embodiments of the disclosure provide a method for device interaction in a virtual scene, where the method is implemented by a second device, the second device is worn on a head of a user and is in a communication connection with a first device, and the method includes:
sending a virtual scene entry request to the first device, where the virtual scene entry request includes a virtual object;
acquiring a facial image of the user;
generating expression data based on the facial image, where the expression data is configured to control the virtual object to display an expression indicated by the expression data;
generating pose data of the user, where the pose data is configured to control the virtual object to display a pose indicated by the pose data; and
sending the pose data and the expression data to the first device.

In a third aspect, the embodiments of the disclosure provide an electronic device. The electronic device includes a processor, a memory, a communication interface, and one or more programs. The one or more programs are stored in the memory and configured to be executed by the processor, and the one or more programs comprise instructions for executing operations in the method in the first aspect and/or the second aspect in the embodiments of the disclosure.

### BRIEF DESCRIPTION OF THE DRAWINGS

In order to more clearly illustrate technical solutions in the embodiments of the disclosure, drawings to be used in the embodiments or the related art are briefly described below. Apparently, the following drawings are merely some embodiments of the disclosure, and those skilled in the art can obtain other drawings according to these drawings without paying any creative effort.

FIG. 1A is a schematic structural diagram of a system for device interaction in a virtual scene according to some embodiments of the disclosure.

FIG. 1B is a schematic diagram of a scenario of virtual scene according to some embodiments of the disclosure.

FIG. 2 is a flowchart of a method for device interaction in a virtual scene according to some embodiments of the disclosure.

FIG. 3 is a schematic diagram of a scenario of a virtual conference according to some embodiments of the disclosure.

FIG. 4 is a schematic diagram illustrating an interaction between two second devices according to some embodiments of the disclosure.

FIG. 5 is a schematic diagram of a collision scenario of bounding boxes according to some embodiments of the disclosure.

FIG. 6 is a flowchart of a method for device interaction in a virtual scene according to some other embodiments of the disclosure.

FIG. 7 is a schematic diagram of a scenario of a virtual scene according to some other embodiment of the disclosure.

FIG. 8 is a flowchart of a method for device interaction in a virtual scene according to yet other embodiments of the disclosure.

FIG. 9 is a schematic structural diagram of an electronic device according to some embodiments of the disclosure.

FIG. 10A is a block diagram of functional units of an apparatus for device interaction in a virtual scene according to some embodiments of the disclosure.

FIG. 10B is a block diagram of functional units of an apparatus for device interaction in a virtual scene according to some other embodiments of the disclosure.

FIG. 11A is a block diagram of functional units of an apparatus for device interaction in a virtual scene according to yet other embodiments of the disclosure.

FIG. 11B is a block diagram of functional units of an apparatus for device interaction in a virtual scene according to still other embodiments of the disclosure.

### DETAILED DESCRIPTION OF PREFERRED EMBODIMENTS

In order to make those skilled in the art better understand the technical solutions of the disclosure, the technical solutions in the embodiments of the disclosure will be described clearly and comprehensively with reference to the drawings in the embodiments of the disclosure. Apparently, the described embodiments are only a part of the embodiments of the disclosure, not all of the embodiments. All other embodiments obtained by those of ordinary skill in the art based on the embodiments of the disclosure without creative efforts fall within the scope of protection of the disclosure.

Terms such as “first”, “second” in the specification and claims of the disclosure and the above-mentioned drawings are used to distinguish different objects, rather than to describe a specific order. In addition, terms “include” and “have” and any transformations thereof are intended to cover nonexclusive inclusions. For example, a process, a method, a system, a product, or a device including a series of operations or units are not limited to the operations or units which have been listed but optionally further includes operations or units which are not listed or optionally further includes other operations or units intrinsic to the process, the method, the product, or the device.

The wording “embodiment” mentioned herein means that a specific feature, a structure or a characteristic described in combination with the embodiment may be included in at least one embodiment of the disclosure. The wording appearing anywhere in the specification does not always refer to the same embodiment or an independent or alternative embodiment mutually exclusive of other embodiments. It is explicitly and implicitly understood by those skilled in the art that the embodiments described in the disclosure may be combined with other embodiments.

An electronic device may be a portable electronic device that includes other functions such as a personal digital assistant function and/or a music player function, for example, the portable electronic device is a mobile phone, a tablet computer, a wearable electronic device with a wireless communication function (such as a smart watch, smart glasses), a vehicle-mounted device. Exemplary embodiments of the portable electronic devices include but are not limited to portable electronic devices equipped with an IOS system, an Android system, a Microsoft system, or other operating systems. The above-mentioned portable electronic device may also be other portable electronic devices, such as a laptop. It should also be understood that, in some other embodiments, the above-mentioned electronic device may not be a portable electronic device, but a desktop computer.

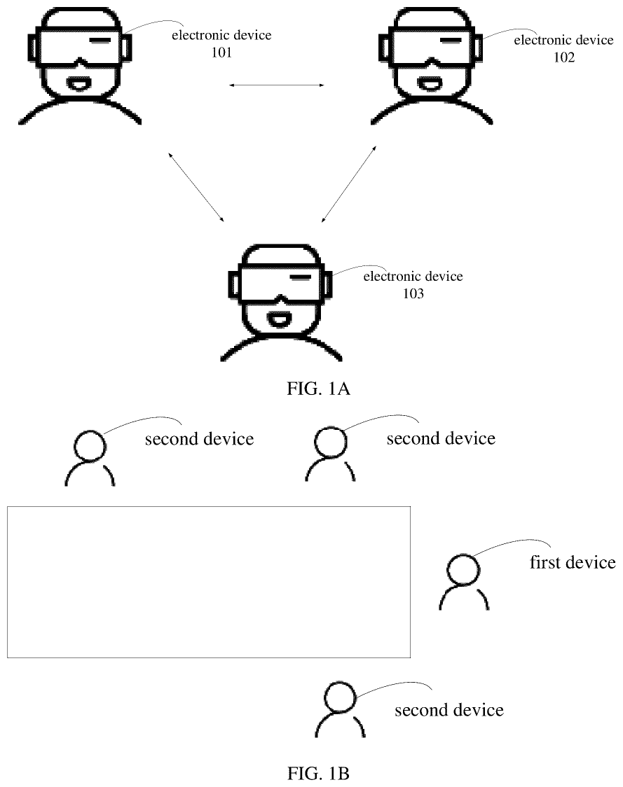

FIG. 1A is a schematic structural diagram of a system for device interaction in a virtual scene to which the disclosure is applied. The system may specifically include an electronic device 101, an electronic device 102, and an electronic device 103.

The electronic device 101, the electronic device 102 and the electronic device 103 are in the same virtual scene, and the virtual scene may be, but is not limited to, a virtual conference scene, a virtual studio scene, a virtual game scene, a virtual museum scene, etc.

The electronic device 101 and/or the electronic device 102 and/or the electronic device 103 may be smart glasses or smart helmets, for example, virtual reality (VR) glasses, and users may access the virtual scene through the electronic device 101 and/or the electronic device 102 and/or the electronic device 103 of the users.

For example, the electronic device 101 and/or the electronic device 102 may be VR glasses, and the electronic device 103 may be a smart watch, a mobile phone, or a tablet computer.

The user may set a virtual object (avatar) through an electronic device of the user (the electronic device 101 and/or the electronic device 102 and/or the electronic device 103). The virtual object may be used to be displayed in the virtual scene, and uniquely identify a 3D appearance or a character image of the user of the electronic device, and the virtual object may be set in terms of facial features, hair, face shape, clothes, height, etc.

The virtual object may be set by the user or a system default, which is not limited here. When the user does not set the virtual object, the electronic device (the electronic device 101 or the electronic device 102 or the electronic device 103) may randomly adapt a pre-set virtual object for the user.

For example, as illustrated in FIG. 1B, FIG. 1B is a schematic diagram of a scenario of a virtual scene according to some embodiments of the disclosure. The virtual scene may include a first device and multiple second devices. The virtual scene may be a virtual conference scene, which may include a host and attendees. As illustrated, the user of the first device may be the host, and the users of the second devices may be the attendees.

In some alternative implementations, the host's first device may be used as a master device of the virtual conference, and the remaining multiple second devices may be slave devices of the virtual conference. The master device (i.e., the first device) may establish communication connections with multiple slave devices (i.e., the multiple second devices). The master device may establish the virtual conference and invite the multiple second devices to enter the virtual conference. Certainly, the multiple second devices may actively initiate a virtual scene entry request, so as to enter the virtual conference.

For example, when the second device is a smart helmet, the attendee may wear the second device, and enter, through the second device, the virtual conference established by the first device.

The second device may include a camera, and the user's facial image may be captured by the camera of the second device. User's expression data may be generated based on the facial image. The expression data may be mapped to the virtual object in the virtual scene, and may be used to drive the face of the virtual object in such a manner that the facial expression of the virtual object is consistent with the facial expression of the user.

The first device and/or the second device may generate pose data of the user, and the pose data may be mapped to the virtual object in the virtual scene, so as to drive the virtual object to perform the same posture as an actual action of the user.

Alternatively, the first device may serve as a data relay device, which may be used to receive pose data and expression data generated by each of the multiple second devices, and synchronize the pose data and the expression data to other second devices, so that each second device may synchronously display the virtual objects corresponding to other second devices. In this way, each second device can be immersed in the virtual conference.

It should be noted that the first device may further generate, based on the pose data and expression data sent by each second device, an image of the virtual scene in real-time, and transmit each image of the virtual scene to each second device, so that each second device may synchronously display the real-time image of the virtual scene.

In the disclosure, the term “multiple (plurality of)” may refer to two or more than two, which will not be repeated hereinafter.

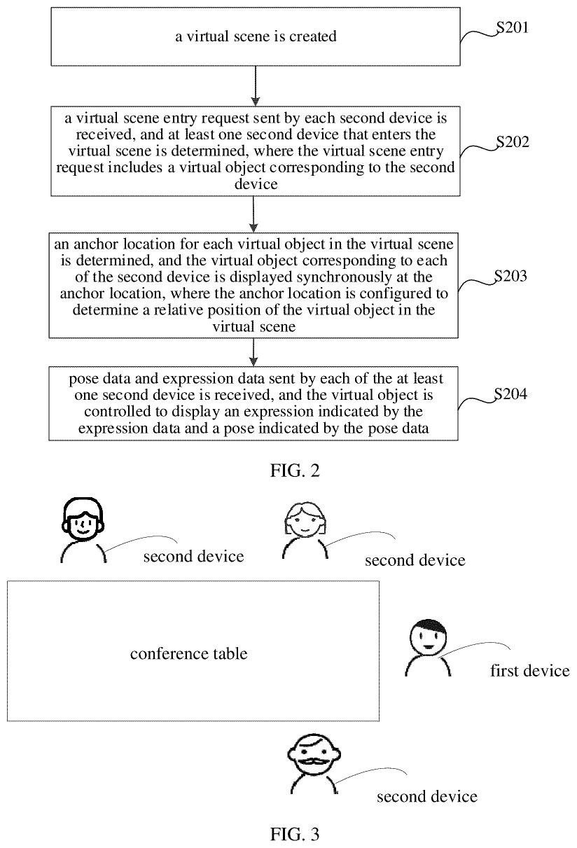

Referring to FIG. 2, FIG. 2 is a flowchart of a method for device interaction in a virtual scene according to some embodiments of the disclosure. The method is implemented by a first device, which is in a communication connection with at least one second device. As illustrated in FIG. 2, the method for device interaction in the virtual scene includes operations as follows.

At S201, a virtual scene is created.

The first device may be any of the electronic devices illustrated in FIG. 1A or the first device illustrated in FIG. 1B. A user of the first device may be a host, and the first device may create the virtual scene desired by the user, in response to a virtual scene establishment instruction from the user.

At S202, a virtual scene entry request sent by each second device is received, and at least one second device that enters the virtual scene is determined, where the virtual scene entry request includes a virtual object corresponding to the second device.

The first device may be a master device for the at least one second device, and may receive the virtual scene entry request sent by any second device. The virtual scene entry request may carry the virtual object set by each second device, and each virtual object may be configured to represent a user of the second device. In some implementations, each second device that enters the virtual scene is determined as a target second device, and the virtual object corresponding to each target second device is acquired from the virtual scene entry request sent by the target second device.

In some alternative implementations, the virtual scene entry request may further carry verification information, which may be used by the first device to verify the identity of the second device. After the verification is passed, it is determined that the second device is allowed to enter the virtual scene, thereby obtaining the at least one second device that enters the virtual scene.

The virtual scene may be, but is not limited to, a virtual conference scene, a virtual studio scene, a virtual game scene, a virtual museum scene, etc. The virtual scene may support multi-person interaction.

At S203, an anchor location for each virtual object in the virtual scene is determined, and the virtual objects corresponding to the each of the second devices is displayed synchronously at the respective anchor location, where the anchor location is configured to determine a relative position of the virtual object in the virtual scene.

When there are at least two second devices, the anchor location for each virtual object in the virtual scene is determined, and the virtual objects corresponding to the individual second devices are displayed simultaneously at the respective anchor locations. The anchor location may be configured to represent an initial location of the virtual object. The initial location where the virtual object enters the virtual scene may be used as the anchor location. The virtual objects corresponding to the individual second devices that enter the virtual scene may be rendered simultaneously at the respective anchor locations. The virtual object may be constructed at the anchor location.

When the first device sets the anchor location for each second device, the first device may set the shape, the radius, and the like, of the anchor. The anchor may be further configured to describe its proportion relative to the virtual scene. When the virtual object is scaled up and rotated, the anchor and the anchor location remain unchanged.

In the embodiments of the disclosure, there is no need to establish a world coordinate system. When pose data of the user represents a movement of the user in the virtual scene, a relative position of a pose of the user relative to the anchor location may be determined, based on the anchor location. A movement direction, a displacement, etc. of the virtual object in the virtual scene may be further determined based on the anchor location and the relative position, and the virtual object is controlled to adjust the movement direction so that the virtual object is moved to the relative position.

At S204, pose data and expression data sent by each of the at least one second device is received, and the virtual object is controlled to display an expression indicated by the expression data and a pose indicated by the pose data.

The pose data may include distances from joint points of the user corresponding to the second device to the second device, degrees of freedom of the second device, etc., which are not limited here. The first device may map the pose data to the virtual object corresponding to the second device, so as to drive the virtual object to animate or move in the pose indicated by the pose data.

The expression data may include an expression base coefficient, an expression base (blendshape) and mesh information of the user of the second device, and the like, which are not limited here. The expression data may be mapped to the virtual object to drive the facial expression of the virtual object to display the expression indicated by the expression data, thereby mapping the real expression of the user of the second device.

The first device may also set a corresponding virtual object. Specifically, the first device may capture a facial image of a user of the first device, determine facial features and hairstyle features of the user based on the facial image, and generate the virtual object of the user of the first device based on the facial features. The virtual object may be configured to uniquely represent the user. For example, when the user has a side-swept fringe, the generated virtual object may also have a side-swept fringe.

The first device may capture the facial images in real time, generate expression data based on the facial images, fit pose data of the user, and drive a corresponding part of the virtual object based on the expression data and the pose data.

For example, as illustrated in FIG. 3, which is a schematic diagram of scenario of a virtual conference, multiple virtual objects may be included in the virtual conference, each virtual object may correspond to one second device, and the virtual objects corresponding to the individual second devices may be different. Each virtual object may be configured to uniquely represent facial features and pose features of the user of the second device.

In some alternative implementations, the first device may also be any second device as illustrated in FIG. 1B. The first device may receive pose data and expression data sent by other second devices, so that the second devices display relevant images of the virtual scene are d in real time.

As can be seen, in the method for device interaction in the virtual scene described in the embodiments of the disclosure, the virtual scene is created, the virtual scene entry request sent by each second device is received, and the at least one second device that enters the virtual scene is determined, where the virtual scene entry request includes the virtual object corresponding to the second device. The anchor location for each virtual object in the virtual scene is determined, and the virtual objects corresponding to the individual second devices are displayed simultaneously at the respective anchor locations, where the anchor location is configured to determine the relative position of the virtual object in the virtual scene. The pose data and the expression data sent by each of the at least one second device is received, and the virtual object is controlled to display the expression indicated by the expression data and the pose indicated by the pose data. In this way, the establishment of the virtual scene may be achieved through an interaction between the first device with the at least one second device, and the virtual scene may be presented realistically through the pose data and the expression data, so that the virtual object in the virtual scene is more realistic, which is conducive to improving user experience. The location and orientation of the virtual object in the virtual scene are adjusted based on the anchor location, and there is no need for each electronic device to individually construct a map or perform pose recognition in real time. This reduces the dependence on visual algorithms and high-precision IMUs, facilitates faster adaptation of the user's pose, and is conducive to improving the rendering efficiency and the rendering quality of the virtual object. The head-mounted first device is conducive to freeing the user's hands, which helps to improve the user's experience.

In a possible example, the method further includes: in response to first pose data sent by any one of the at least one second device, determining a first virtual object corresponding to the first pose data, and determining a first current location of the first virtual object based on the first pose data and the anchor location of the first virtual object (which is also referred to as a first anchor location); in response to second pose data sent by another second device in the at least one second device except the second device corresponding to the first virtual object, determining a second virtual object corresponding to the second pose data, and determining a second current location of the second virtual object based on the second pose data and the anchor location of the second virtual object (which is also referred to as a second anchor location); and detecting, based on the first current location and the second current location, whether there is a risk of collision between the first virtual object and the second virtual object.

In a specific scenario, the first pose data may be pose data newly sent by the corresponding second device, which is different from the pose data sent for the first time. Similarly, the second pose data may be pose data newly sent by the corresponding second device.

In a particular implementation, the first virtual object and the second virtual object may form a pair of comparison objects, and the electronic device may determine a first relative position of the first virtual object and the pose of the user, based on a first anchor location and the distance in the first pose data. Similarly, the second relative position of the second virtual object and the pose of the user may be determined based on the distance in the second pose data and a second anchor location. Further, the first current location of the first virtual object and the second current location of the second virtual object may be determined, based on the first relative position and the second relative position, respectively. The first current location and the second current location may be in the same coordinate system, and the first relative position and the second relative position each exist relative to the anchor location, and they do not need to be in the same coordinate system.

For example, in the operation of determining the first current location of the first virtual object and the second current location of the second virtual object based on the first relative position and the second relative position respectively, the electronic device establishes a coordinate system based on the first anchor location and the second anchor location, and based on the coordinate system, the electronic device transforms coordinates of the first relative position to obtain the first current location, and transforms coordinates of the second relative position to obtain the second current location.

As can be seen that, in this example, after any two different second devices among the at least one second device update pose data, a collision risk detection may be performed. In response to detecting a risk of collision between the first virtual object and the second virtual object, the current location of the first virtual object and/or the current location of the second virtual object may be adjusted to avoid the collision between the first virtual object and the second virtual object corresponding to the two second devices.

In a possible example, after detecting whether there is the risk of collision between the first virtual object and the second virtual object, the method further includes: determining a to-be-collided point, in response to detecting the risk of collision between the virtual objects corresponding to any two of the second devices; determining, based on the to-be-collided point, a first collision action and a second collision action corresponding to the any two virtual objects respectively, a first joint point corresponding to the first collision action, and a second joint point corresponding to the second collision action; determining, based on the first collision action and the second collision action, whether the second device corresponding to the first virtual object triggers an interactive operation on the first virtual object, and/or whether the second device corresponding to the second virtual object triggers an interactive operation on the second virtual object.

The to-be-collided point may be a collision point at which the collision will occur between any two virtual objects (which may include the first virtual object and the second virtual object in the disclosure, and which will not be repeated hereinafter) which are predicted by the first device as being at the risk of collision.

In a real situation, a collision situation may also be caused by any two virtual objects performing an appropriate collision action based on an interactive operation, i.e., the above risk of collision may also be a collision situation that is allowable in the virtual scene. The first device may preset a type of collision action that allows the collision situation to occur (which may include the first collision action and/or the second collision action in the disclosure, and will not be repeated hereinafter), for example, it may include a clapping collision, and a handshake collision.

The collision operation may be generated or determined by the interactive operation desired by the users of the two virtual objects. The collision action may be generated by the user based on the type of collisions that are allowed to occur, in which the collision action may reflect that the collision action generated by the interactive operation is appropriate. For example, the interactive operation may refer to a dynamic interaction, which may be a clapping interactive operation between two users, a handshake interactive operation, etc.

As can be seen, in this example, after detecting the risk of collision between any two second devices, it may be further detected whether the collision action corresponding to the risk of collision is an allowed collision action. In other words, it may be determined whether the collision action is a collision situation that the allowable or appropriate interaction operation is performed in the virtual scene. In this way, it is beneficial to increase the user's immersive experience.

In a possible example, the operation of determining, based on the first collision action and the second collision action, whether the second device corresponding to the first virtual object triggers the interactive operation on the first virtual object, and/or whether the second device corresponding to the second virtual object triggers the interactive operation on the second virtual object, includes: in response to the first collision action and the second collision action being a same collision type, determining that the second device corresponding to the first virtual object triggers the interactive operation on the first virtual object, and/or the second device corresponding to the second virtual object triggers the interactive operation on the second virtual object; determining a collision point and collision information corresponding to the collision point upon the collision between the first virtual object and the second virtual object, where the collision information includes a collision speed and a collision plane; determining a first collision animation for the first joint point and a second collision animation for the second joint point; adjusting a display location of the first collision animation and a display location of the second collision animation, based on the collision speed and the collision plane; and sending the adjusted display location of the first collision animation to the second device corresponding to the first virtual object, and sending the adjusted display location of the second collision animation to the second device corresponding to the second virtual object.

When the first collision action and the second collision action are of the same type, or are collision actions allowable to occur by the first device, the first device may determine that the users of the two virtual objects that are at the risk of collision have triggered the interactive operation for the two virtual objects in the virtual scene. The interactive operation may be triggered by the two users at the same time. Alternatively, the second device corresponding to the first virtual object may trigger the interactive operation for the second virtual object, or the second device corresponding to the second virtual object may trigger the interactive operation for the first virtual object, etc.

The collision information may be obtained through detection upon collision of the two virtual objects. The collision information may include at least one of the following: the collision speed, the collision plane, a collision duration, a collision vector, etc., which are not limited here. The collision speed may refer to a collision speed of each virtual object upon collision of the two virtual objects. The collision plane may refer to a common plane defined by the collision point and collision vector upon collision of the two virtual objects. The collision information may be configured to determine a collision action, a collision reaction and a collision effect of the two virtual objects upon the collision, and the collision reaction and/or the collision effect may be presented through the collision animation.

Since the collision action is generally performed by the corresponding joint points in the virtual object, the first device may set different collision animations for different joint points, and each second device may correspond to a different collision animation for the joint points. Certainly, the collision animation may also be set by the second device and transmitted to the first device.

The first device may set a playback frequency or a playback speed of the collision animation based on the collision speed.

Specifically, after determining the collision plane, the first device may adjust a display location of the first collision animation and a display location of the second collision animation, so that the first collision animation of the first joint point for the first collision action and the second collision animation of the second joint point for the second collision action are adjusted to be in the same collision plane. The playback frequency and/or the playback speed of the collision animation are adjusted based on the collision speed. The adjusted display location, the adjusted playback frequency and/or playback speed of the first collision animation are synchronized to the second device corresponding to the virtual object having the first joint point, and the adjusted display location, the adjusted playback frequency and/or playback speed of the second collision animation are synchronized to the second device corresponding to the virtual object having the second joint point, so that the collision animation that meets the setting of each second device is displayed synchronously in the respective second device.

Furthermore, the adjusted collision animation (the adjusted first collision animation or the second collision animation) of any one of the collision actions may be randomly displayed in the virtual scene, and the adjusted collision animation of the any one of the collision actions may be synchronized to another second device for which the collision situation has not occurred or for which the interaction operation has not occurred, so as to achieve synchronous display of the virtual scene.

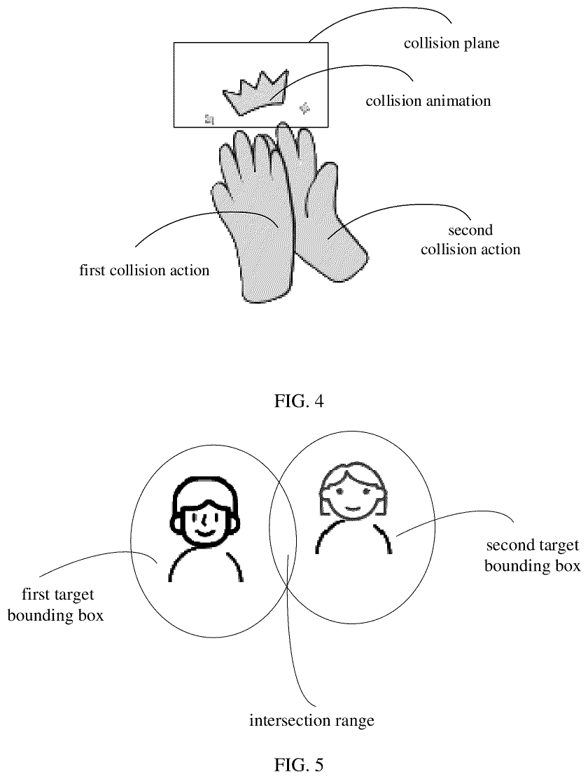

For example, as illustrated in FIG. 4, which is a schematic diagram illustrating an interaction between two second devices. When the first collision action of the first virtual object and the second collision action of the second virtual object are of the same collision type, and both are a clapping action allowed a collision to occur, the first joint point of the first virtual object and the second joint point of the second virtual object correspond to a same preset collision animation. The adjusted collision animation, i.e., the clapping action and the collision animation of the clapping action, of the virtual scene may be displayed synchronously in the collision plane for each second device.

It should be noted that, when the virtual object corresponding to the first device collides or interacts with the virtual object corresponding to any second device, this may also be implemented through the above method, and details thereof will not be repeated here.

It can be seen that, in this example, the second devices of two different users are allowed to generate the appropriate interactive operations therebetween, which is conducive to increasing the authenticity of the virtual scene. A dynamic collision between the two virtual objects is illustrated by the collision animation, which is conducive to increasing interest of the immersive experience of the virtual scene. Furthermore, the first device may adjust the collision animation of each of the two second devices that collide, and send the adjusted collision animation to the respective second device. In this way, the second device may display the respective collision animation that it wishes to display, which is conducive to improving the user experience of the users of the various second devices.

In a possible example, the operation of detecting, based on the first current location and the second current location, whether there is the risk of collision between the first virtual object and the second virtual object, includes: determining a first target bounding box of the first virtual object and a second target bounding box of the second virtual object, based on the first current location and the second current location respectively; in response to an intersection between the first target bounding box and the second target bounding box, determining an intersection range of the intersection; and detecting, based on the intersection range, whether there is the risk of collision between the first virtual object and the second virtual object.

The first target bounding box and/or the second target bounding box may refer to an enclosed space that encloses the virtual object and/or a subsequent virtual item by using a simple geometric body, and may be configured to detect whether there is a collision between the two virtual objects, or between the virtual object and the virtual item. A shape of the bounding box may be set by the user or by the system default, which is not limited here. The shape of the first target bounding box and/or the second target bounding box may be circular, spherical, cubic, etc.

In a particular implementation, the first target bounding box of the first virtual object and the second target bounding box of the second virtual object may be constructed respectively, based on the first virtual object and the second virtual object, as well as the first current location and the second current location. Along with a movement or a displacement of the virtual object, it is determined whether there is an intersection between the first target bounding box and the second target bounding box. When it is determined that there is an intersection, it indicates that there may be the risk of collision between the first virtual object and the second virtual object. Furthermore, the intersection range of the intersection may be determined, and it is determined, based on the intersection range, whether there is the risk of collision between the first virtual object and the second virtual object.

As can be seen, in this example, whether any two virtual devices would have a risk of collision or would collide with each other may be monitored by detecting whether there is an intersection of the bounding boxes, which is helpful for avoiding the occurrence of a subsequent collision between the two virtual objects.

In a possible example, when the intersection range is greater than or equal to a preset threshold, it is determined that there is the risk of collision between the any two virtual objects; and when the intersection range is less than the preset threshold, it is determined that there is no risk of collision between the any two virtual objects.

The preset threshold may be set by the user or by the system default, which is not limited here. The preset threshold is configured to evaluate whether the bounding boxes of the two virtual objects will collide, so as to further determine a possibility of the risk of collision between the two virtual objects. The larger the intersection range of the two bounding boxes, the greater the possibility of the collision risk.

The electronic device may determine, by comparing the intersection range with the preset threshold, whether or not there is the risk of collision between the first virtual object and the second virtual object.

For example, FIG. 5 is a schematic diagram of a collision scenario of bounding boxes. The first target bounding box corresponds to the first virtual object, the second target bounding box corresponds to the second virtual object, and the first target bounding box and/or the second target bounding box are both elliptical. As the first virtual object and the second virtual object move, an occurrence of an intersection situation and an intersection range of the intersection situation may be determined based on ranges of the first target bounding box and/or the second target bounding box respectively. When the intersection range is greater than or equal to the preset threshold, it indicates there is a risk of collision between the two virtual objects.

In some alternative implementations, the first device may determine a difference between the intersection range and the preset threshold. The greater the difference between the intersection range and the preset threshold, the greater the risk of collision is indicated. When the difference is greater than or equal to a preset difference (which may be set by the user or by the system default, and the preset difference may refer to a difference between a maximum lateral distance of the intersection range and the preset threshold value when the collision occurs) and it is determined that there is no interaction operation between the first virtual object and the second virtual object, the first device may adjust a distance between the first virtual object and the second virtual object such that the two virtual objects do not collide.

As can be seen, in this example, whether any two second devices would have the risk of collision or would collide with each other may be monitored by detecting whether there is an intersection of the bounding boxes, which is helpful for avoiding the occurrence of a subsequent collision between the two virtual objects.

In a possible example, the operation of determining, based on the first current location and the second current location, the first target bounding box of the first virtual object and the second target bounding box of the second virtual object respectively, may include: constructing a same three-dimensional coordinate system, based on the first current location and the second current location, and constructing a first bounding box of the first virtual object and a second bounding box of the second virtual object in the three-dimensional coordinate system, where the first bounding box includes a first center and multiple first vertices, and the second bounding box includes a second center and multiple second vertices; obtaining a first target bounding box by correcting the first bounding box with the multiple first vertices of the first bounding box traversed; and obtaining a second target bounding box by correcting the second bounding box with the multiple second vertices of the second bounding box traversed.

The three-dimensional coordinate system may be configured to represent the location of the bounding box of the virtual object in the virtual scene. The first bounding box and/or the second bounding box are 3D bounding boxes. The three-dimensional coordinate system may include six directions consisting of positive/negative directions of an x-axis, positive/negative directions of a y-axis, and positive/negative directions of a z-axis.

The construction of the first bounding box of the first virtual object performed by the first device may specifically include that: the first device may determine, based on the first current location and the anchor location of the first virtual object in the virtual scene, six points of the first virtual object at the farthest distances in the six directions respectively, thereby obtaining the multiple first vertices. Specifically, there are two vertices on each axis, and a length between the two vertices on each axis is determined to obtain three lengths. The maximum length is determined as a diameter of the first bounding box, and a center point of the maximum length is determined as the first center to construct a sphere, thereby obtaining the first bounding box corresponding to the first virtual object.

Furthermore, since not all the first vertices are within the first bounding box, the first bounding box may be modified. The multiple first vertices of the first bounding box may be traversed, so as to obtain any one of the vertices outside the first bounding box, which may be referred to as an outer vertex, and the vertices in the first bounding box may be ignored. A first outer center between the outer vertex and the first vertex is determined, and the first outer center is taken as a new first center. A distance between the outer vertex and the first vertex is taken as a diameter of a new first bounding box, and thus a radius of the new first bounding box is obtained. A length between the new first center and the first center is calculated, and a translation vector of the first bounding box is determined based on the calculated length. Based on the translation vector, the first center of the first bounding box is translated, and the new first bounding box is generated with the radius of the new first bounding box. In this way, the above manner may be looped, so as to obtain the first vertex outside the new first bounding box by traversing, and all other outer vertices are traversed to iteratively correct the new first bounding box, thereby obtaining a final completely new first bounding box, that is, a spherical first target bounding box which is completely new.

It is notable that, similarly, the second bounding box and the second target bounding box of the second virtual object may be obtained in the same way as described above, and the details will not be repeated here.

As can be seen, in this example, after the construction of the three-dimensional coordinate system, the first bounding box of the first virtual object and the second bounding box of the second virtual object may be located in the same three-dimensional coordinate system. The first bounding box may be corrected iteratively by traversing the multiple first vertices of the first bounding box and the second bounding box may be corrected iteratively by traversing the multiple second vertices of the second bounding box, thereby obtaining the new spherical bounding boxes, such that all the first vertices are in the first target bounding box, and all the second vertices are in the second target bounding box. In this way, the first virtual object is in the first target bounding box, and the second virtual object is in the second target bounding box. In addition, the obtained first target bounding box and second target bounding box are not too large, which can accurately reflect the range of the first virtual object and/or the second virtual object in the virtual scene. Furthermore, no part of the virtual object is neglected in the subsequent collision risk detection process, which is conducive to improving the accuracy of collision risk detection.

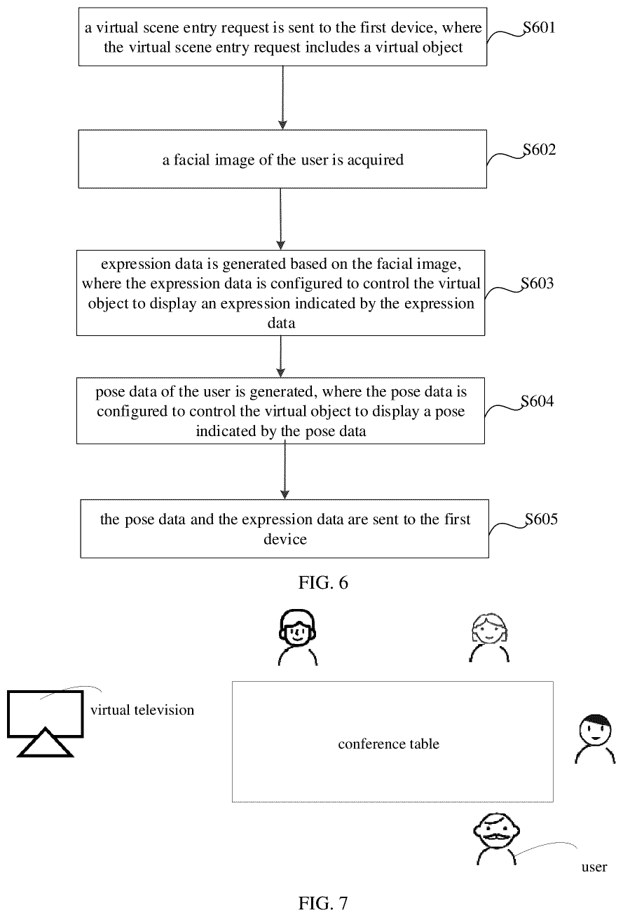

Consistent with the foregoing, referring to FIG. 6, FIG. 6 is a flowchart of a method for device interaction in a virtual scene according to some other embodiments of the disclosure. The method is implemented by a second device, which is worn on a head of a user and is in a communication connection with a first device. As illustrated in FIG. 6, the method for device interaction in the virtual scene includes operations as follows.

At S601, a virtual scene entry request is sent to the first device, where the virtual scene entry request includes a virtual object.

At S602, a facial image of the user is acquired.

The second device may include a camera. Since the second device is worn on the user's head, the clear facial image of the user may be captured.

At S603, expression data is generated based on the facial image, where the expression data is configured to control the virtual object to display an expression indicated by the expression data.

At S604, pose data of the user is generated, where the pose data is configured to control the virtual object to display a pose indicated by the pose data.

At S605, the pose data and the expression data are sent to the first device.

For a detailed description of S601 to S605, reference may be made to the corresponding steps of S201 to S203 of the method for device interaction in the virtual scene illustrated in FIG. 2, and details will not be repeated here.

It is notable that, the expression data and/or the pose data are synchronously mapped to the virtual object by the first device. In addition, the first device may further synchronously transmit the virtual objects corresponding to all associated second devices back to the second devices. In this way, the user can experience the immersive virtual scene.

As can be seen from the above, in the method for device interaction in the virtual scene according to the embodiments of the disclosure, the virtual scene entry request is sent to the first device, where the virtual scene entry request includes the virtual object. The facial image of the user is acquired, and the expression data is generated based on the facial image, where the expression data is configured to control the virtual object to display the expression indicated by the expression data. The pose data of the user is generated, where the pose data is configured to control the virtual object to display the pose indicated by the pose data. The pose data and the expression data are sent to the first device. As such, the establishment of the virtual scene may be achieved through the interaction between the second device with the first device, and the virtual scene may be presented realistically through the pose data and the expression data, so that the virtual object in the virtual scene is more realistic, and it is conducive to improving the rendering efficiency and the rendering quality of the virtual object and/or virtual object. The head-mounted first device facilitates the user to free their hands and facilitate the immersive experience of the virtual scene, thus contributing to the improvement of the user experience.

In a possible example, in the above method, generating the expression data based on the facial image includes: generating multiple facial key points based on the facial image; dividing the multiple facial key points into multiple key point sets; generating mesh information of the facial image, based on the face key points; determining multiple expression base coefficients of the user, based on the mesh information and the multiple key point sets, where each of the multiple expression base coefficients corresponds to one expression base; and generating the expression data based on the multiple expression base coefficients, the mesh information and the expression bases, where the expression data is configured to drive a face of the virtual object to present an expression of the user.

Specifically, the generation manner of the key points may include at least one of: speeded up robust feature (SURF), scale invariant feature transform (SIFT), features from accelerated segment test (FAST), Harris corner method, etc., which are not limited here.

Each of the key point sets may correspond to a respective facial muscle area of the user. The facial muscle area may be set in advance by the second device, for example, the facial muscle area may be set according to a standard facial image, and each facial muscle area may correspond to a partial area on the face (such as an area of a left eye, a right eye, a mouth, an ear, a left eyebrow, a right eyebrow, which is not limited here). The expression of the user may be reflected by a combination of the key point sets corresponding to the facial muscle areas.

The expression base may include at least one of the following: a wink, a beak, a tongue, a raised eyebrow, and the like, which is not limited herein.

The expression may include at least one of the following: angry, happy, crying, smiling, frustrated, excited, and the like, which is not limited herein. The expression base is used to represent the expression of the user. The expression base coefficient may be configured to represent intensities of different expressions.

Each expression base may correspond to one expression base coefficient, and the multiple expression base coefficients corresponding to the multiple expression bases are configured to have a combined influence on the current expression of the user.

Specifically, the mesh information may include at least one of the following: information of longitude and latitude lines obtained from a division of facial parts, information of a patch defined by connecting the key points, and the like, which is not limited here. The mesh information may include meshes that are consisted of vertices and surfaces, having latitude and longitude lines, and formed based on combination of the key points of the face, in which intersection points of the latitude and longitude lines may be locations of the key points of the face.

A change of the locations of the key points in the key point set corresponding to each facial muscle area relative to the key points of the standard face is configured to represent the expression base coefficient.

The expression data may include at least one of the following: the expression base coefficient, the mesh information, the expression base, etc., which is not limited here.

As can be seen, in this example, the current expression base and expression base coefficient of the user may be determined based on the facial muscle area and the mesh information. The expression base coefficient may be configured to reflect the current expression change of the user and the like. In this way, the expression data may be obtained, which is conducive to accurately determining the change in the facial expression. The expression data may be mapped to the virtual object, so that the user's real expression is consistent with the expression of the virtual object.

In a possible example, the user includes multiple joint points, and generating the pose data of the user, includes: receiving multiple mark signals from the multiple joint points, where each of the multiple joint points corresponds to one of the multiple mark signals; calculating a distance from each of the multiple joint points to the second device based on the multiple mark signals, thereby obtaining multiple distances of the multiple joint points; and the pose data of the user is generated based on the multiple distances.

The joint points may include at least one of the following: an elbow, a shoulder, a wrist, an ankle, a leg bend, a knee, a hip, and the like, which is not limited herein.

A mark signal patch may be attached at the joint point of the user of the second device, and the mark signal may be sent through the mark signal patch. The second device may receive the mark signal through communicate with the mark signal patch. A distance between the head and other joint points, i.e., the distance, may be estimated based on a transmission time, a reception time, and the like of the mark signal.

The second device may determine a pose (a location and an attitude) of each joint point based on the distance of each joint point relative to the head or the second device, thereby obtaining the pose data of the joint point of the user.

As can be seen, in this example, an approximate human pose of the user of the second device may be obtained through an estimation based on the mark signal patches. The pose data is mapped to the virtual object of the virtual scene, so that the virtual scene can realistically present a real meeting scene, museum scene, or concert scene, etc. Compared with map construction and real-time pose recognition based on SLAM, in such embodiments, it is more convenient and easier to use, the user can freely choose a location of the patch to show their body pose, which is conducive to improving the user experience.

In a possible example, the method may further include: acquiring an angular velocity, an acceleration, and a magnetic field direction detected by the second device; determining a degree of freedom of the second device, based on the angular velocity, the acceleration and the magnetic field direction, where the degree of freedom is configured to represent a change in rotation of a head and a change in body displacement of the virtual object; and the pose data of the user is generated based on the degree of freedom and the multiple distances.

Specifically, the second device may include a gyroscope, an accelerometer, a magnetometer and other devices, which is not limited here. The angular velocity, the acceleration and the magnetic field direction of the movement of the user may be detected in real time through a means such as the gyroscope, the accelerometer, and the magnetometer.

The magnetic field direction may refer to a signal of north, east, south and west directions relative to the earth magnetic field. The angular velocity may be relative to the anchor location.

The degree of freedom (DoF) parameter is configured to represent the change in rotation of the head and the change in the displacement of the body of the virtual object. The degrees of freedom may include the degrees of freedom on a translation of the second device in three directions, i.e., up and down, front and back, and left and right, so as to represent a change of the displacement in the up and down direction, left and right direction, front and back direction caused by a movement of the user's body. The degrees of freedom may also include the degrees of freedom on three rotation angles of pitch, roll, and yaw, so as to detect a change in an angle of view caused by the rotation of the head.

The pose data include the degree of freedom and the multiple distances.

As can be seen, in this example, the angular velocity, the acceleration, the magnetic field direction, etc. may be detected by a common apparatus such as a gyroscope, an accelerometer, and a magnetometer. The detected angular velocity, acceleration, magnetic field direction are combined with the multiple distances, so as to determine the pose data of the user of the second device. In this way, there is no need for an inertial measurement unit with high accuracy, which is conducive to saving hardware resources.

In a possible implementation, the method may further include: obtaining an object location of a virtual item in the virtual scene and an anchor location of the virtual object in the virtual scene; determining a current location of the virtual object of the user relative to the anchor location, based on the multiple distances and the anchor location; determining, based on the current location and the object location, whether or not the user has triggered an interactive operation on the virtual item; and in response to determining that the user has triggered the interactive operation on the virtual item, the virtual item is controlled to respond to the interactive operation.

In addition to a conference table and the multiple virtual objects, the virtual scene may further include static objects such as a virtual wall, a virtual wall light, a virtual door, and a virtual television.

After creating the virtual scene, the first device may determine the object location of each virtual item.

The interactive operation may refer to a static interactive operation performed on the virtual item, and may include at least one of the following: turning on a light, turning off a light, closing a door, turning on the virtual TV, etc., which is not limited here.

In a particular implementation, whether or not the virtual object of the user has a risk of collision with the virtual item may be determined based on the current location and the object location. The collision detection method is similar to the method for detecting whether there is a risk of collision between virtual objects corresponding to any two of the at least one second device described in FIG. 2, and details will not be repeated here.

Furthermore, when it is determined that there is the risk of collision between the virtual object corresponding to the user and the virtual item, a collision action of the virtual object is acquired. When the collision action satisfies a preset interactive operation between the virtual object and the virtual item, it may be determined that the user has triggered the interactive operation on the virtual item. In response to the interactive operation, the virtual item may be controlled to perform a corresponding operation, which may be to turn off the light, close the door, turn on the virtual TV, etc., and this is not limited here.

For example, FIG. 7 is a schematic diagram of a scenario of a virtual scene, in which the virtual scene may be a virtual conference scene. The virtual conference scene may include the virtual items such as the conference table and the virtual TV. The user of the second device may trigger an interactive operation on the virtual TV, i.e., a power-on operation. The virtual TV is controlled by the second device to respond to the power-on operation, so as to turn on the virtual TV.

It is notable that, the second device may control any virtual item in the virtual scene to respond to the interactive operation initiated at the second device, and synchronize the interactive operation to the first device, and the interactive operation is sent to other second devices, so that the virtual item responds to the interactive operation in the virtual scene displayed at each second device. In this way, the images in the virtual scene displayed at the individual devices are synchronized.

As can be seen, in this example, the second device may realize the interactive operation on the virtual item in the virtual scene, and control, based on the interactive operation, the virtual item to implement a function corresponding to the interactive operation, which is conducive to increasing a sense of reality of the virtual conference.

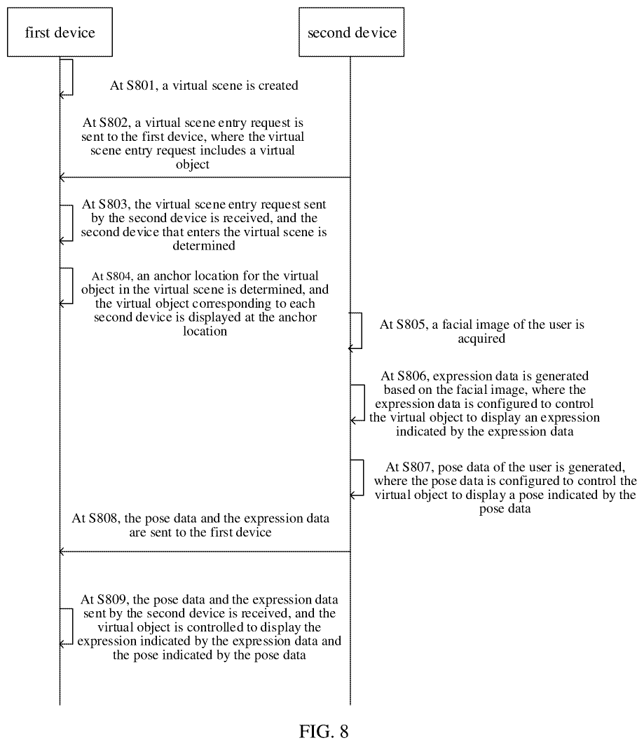

FIG. 8 is a flowchart of a method for device interaction in a virtual scene according to yet other embodiments of the disclosure. A first device establishes a communication connection with at least one second device, the second device is worn on a user's head, and the second device in these embodiments of the disclosure is any one of the at least one second device. As illustrated in FIG. 8, the device interaction in the virtual scene includes operations as follows.

At S801, the first device creates a virtual scene.

At S802, each second device sends a virtual scene entry request to the first device, where the virtual scene entry request includes a virtual object.

At S803, the first device receives the virtual scene entry request sent by each second device, and determines the second devices that enter the virtual scene.

At S804, the first device determines an anchor location for the virtual object in the virtual scene, and simultaneously displays the virtual objects corresponding to the second devices at the respective anchor locations.

At S805, the second device acquires a facial image of the user.

At S806, the second device generates expression data based on the facial image, where the expression data is configured to control the virtual object to display an expression indicated by the expression data.

At S807, the second device generates pose data of the user, where the pose data is configured to control the virtual object to display a pose indicated by the pose data.

At S808, the second device sends the pose data and the expression data to the first device.

At S809, the first device receives the pose data and the expression data sent by the second device, and controls the virtual object to display the expression indicated by the expression data and the pose indicated by the pose data.

In some alternative implementations, for the specific description of S801 to S809, reference may be made to S201 to S204 of the method for device interaction in the virtual scene as illustrated in FIG. 2, and S601 to S605, and details will not be repeated here.

As can be seen, in the method for device interaction in the virtual scene described in the embodiments of the disclosure, the first device creates the virtual scene and the second device sends the virtual scene entry request to the first device, where the virtual scene entry request includes the virtual object. The first device receives the virtual scene entry request sent by the second device, and determines the second device that enters the virtual scene. The first device determines the anchor location for the virtual object in the virtual scene, and displays the virtual objects corresponding to the individual second devices synchronously at the respective anchor locations. The second device acquires the facial image of the user, and generates the expression data based on the facial image, where the expression data is configured to control the virtual object to display the expression indicated by the expression data. The second device generates the pose data of the user, where the pose data is configured to control the virtual object to display the pose indicated by the pose data. The second device sends the pose data and the expression data to the first device. The first device receives the pose data and the expression data sent by the second device, and controls the virtual object to display the expression indicated by the expression data and the pose indicated by the pose data. In this way, the establishment of the virtual scene may be achieved through an interaction between the first device with the second device, and the virtual scene may be presented realistically through the pose data and the expression data, so that the virtual object in the virtual scene is more realistic, which is conducive to improving the user experience. The location and orientation of the virtual object in the virtual scene are adjusted based on the anchor location, and there is no need for each electronic device to individually construct a map or perform pose recognition in real time. This reduces the dependence on high-precision visual algorithms and IMU units, facilitates faster adaptation of the user's pose, and is conducive to improving the rendering efficiency and the rendering quality of the virtual object. The head-mounted first device is conducive to freeing the user's hands, which helps to improve the user's experience.

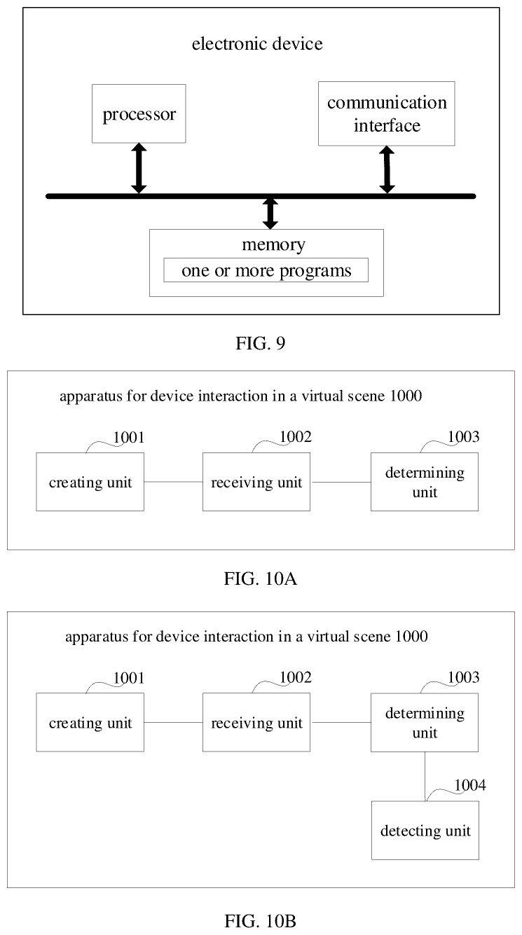

Referring to FIG. 9, FIG. 9 is a schematic structural diagram of an electronic device according to some embodiments of the disclosure. As illustrated in FIG. 9, the electronic device includes a processor, a memory, a communication interface, and one or more programs executable by the electronic device.

In some alternative implementations, when the electronic device is a first device, the first device establishes a communication connection with at least one second device, the one or more programs are stored in the memory, and the one or more programs are configured to cause the processor to execute operations including:
creating a virtual scene;
receiving a virtual scene entry request sent by each of the at least one second device, and determining at least one of the at least one second device that enters the virtual scene, where the virtual scene entry request sent by each second device includes a virtual object corresponding to the second device;
determining an anchor location for each virtual object in the virtual scene, and displaying the virtual object corresponding to each of the second device synchronously at the respective anchor location, where the anchor location is configured to determine a relative position of the virtual object in the virtual scene; and
receiving pose data and expression data sent by each of the at least one second device, and controlling the virtual object to display an expression indicated by the expression data and a pose indicated by the pose data.

As can be seen that, for the electronic device described in the embodiments of the disclosure, the virtual scene is created, the virtual scene entry request sent by each second device is received, and the at least one second device that enters the virtual scene is determined, where the virtual scene entry request includes the virtual object corresponding to the second device. The anchor location for each virtual object in the virtual scene is determined, and the virtual objects corresponding to the individual second devices are displayed simultaneously at the respective anchor locations, where the anchor location is configured to determine the relative position of the virtual object in the virtual scene. The pose data and the expression data sent by each of the at least one second device is received, and the virtual object is controlled to display the expression indicated by the expression data and the pose indicated by the pose data. In this way, the establishment of the virtual scene may be achieved through an interaction between the first device with the at least one second device, and the virtual scene may be presented realistically through the pose data and the expression data, so that the virtual object in the virtual scene is more realistic, which is conducive to improving user experience. The location and orientation of the virtual object in the virtual scene are adjusted based on the anchor location, and there is no need for each electronic device to individually construct a map or perform pose recognition in real time. This reduces the dependence on visual algorithms and high-precision IMUs, facilitates faster adaptation of the user's pose, and is conducive to improving the rendering efficiency and the rendering quality of the virtual object and/or virtual object. The head-mounted first device is conducive to freeing the user's hands, which helps to improve the user's experience.

In a possible example, the program further includes instructions for executing operations including:
in response to first pose data sent by any one of the at least one second device, determining a first virtual object corresponding to the first pose data, and determining, based on the first pose data and the anchor location of the first virtual object, a first current location of the first virtual object;
in response to second pose data sent by another second device in the at least one second device except the second device corresponding to the first virtual object, determining a second virtual object corresponding to the second pose data, and determining, based on the second pose data and the anchor location of the second virtual object, a second current location of the second virtual object; and
detecting, based on the first current location and the second current location, whether there is a risk of collision between the first virtual object and the second virtual object.

After detecting whether there is the risk of collision between the first virtual object and the second virtual object, the program includes instructions for executing the following operations:
determining a to-be-collided point, in response to detecting the risk of collision between the virtual objects corresponding to any two of the second devices;
determining, based on the to-be-collided point, a first collision action and a second collision action of the any two virtual objects respectively, a first joint point for the first collision action, and a second joint point for the second collision action; and
determining, based on the first collision action and the second collision action, whether the second device corresponding to the first virtual object triggers an interactive operation on the first virtual object, and/or whether the second device corresponding to the second virtual object triggers an interactive operation on the second virtual object.

In a possible example, in the aspect of determining, based on the first collision action and the second collision action, whether the second device corresponding to the first virtual object triggers the interactive operation on the first virtual object, and/or whether the second device corresponding to the second virtual object triggers the interactive operation on the second virtual object, the program includes instructions for executing the following operations:
in response to the first collision action and the second collision action being a same collision type, determining that the second device corresponding to the first virtual object triggers the interactive operation on the first virtual object, and/or the second device corresponding to the second virtual object triggers the interactive operation on the second virtual object;
determining a collision point and collision information at the collision point upon the collision between the first virtual object and the second virtual object, where the collision information includes a collision speed and a collision plane;
determining a first collision animation for the first joint point and a second collision animation for the second joint point;
adjusting, based on the collision speed and the collision plane, a display location of the first collision animation and a display location of the second collision animation; and
sending the adjusted display location of the first collision animation to the second device corresponding to the first virtual object, and sending the adjusted display location of the second collision animation to the second device corresponding to the second virtual object.

In a possible example, in the aspect of detecting, based on the first current location and the second current location, whether there is the risk of collision between the first virtual object and the second virtual object, the program includes instructions for executing the following operations:
determining, based on the first current location, a first target bounding box of the first virtual object, and determining, based on the second current location, a second target bounding box of the second virtual object;
in response to an intersection between the first target bounding box and the second target bounding box, determining an intersection range of the intersection; and
detecting, based on the intersection range, whether there is the risk of collision between the first virtual object and the second virtual object.

In a possible example, in the aspect of determining, based on the first current location, the first target bounding box of the first virtual object and determining, based on the second current location, the second target bounding box of the second virtual object, the program further includes instructions for executing the following operations:
constructing, based on the first current location and the second current location, a same three-dimensional coordinate system, and constructing the first bounding box of the first virtual object and the second bounding box of the second virtual object in the three-dimensional coordinate system, where the first bounding box includes a first center and multiple first vertices, and the second bounding box includes a second center and multiple second vertices;
obtaining a first target bounding box, by correcting the first bounding box with the multiple first vertices of the first bounding box traversed; and
obtaining a second target bounding box, by correcting the second bounding box with the multiple second vertices of the second bounding box traversed.

In some alternative implementations, when the electronic device is a second device, the second device is worn on a head of a user, and the second device is in a communication connection with the first device; the one or more programs are stored in the memory, and the one or more programs are configured to cause the processor to execute the following operations:
sending a virtual scene entry request to the first device, where the virtual scene entry request includes a virtual object;
acquiring a facial image of the user;
generating expression data based on the facial image, where the expression data is configured to control the virtual object to display an expression indicated by the expression data;
generating pose data of the user, where the pose data is configured to control the virtual object to display a pose indicated by the pose data; and
sending the pose data and the expression data to the first device.

As can be seen that, for the device described in the embodiments of the disclosure, the virtual scene entry request is sent to the first device, where the virtual scene entry request includes the virtual object. The facial image of the user is acquired, and the expression data is generated based on the facial image, where the expression data is configured to control the virtual object to display the expression indicated by the expression data. The pose data of the user is generated, where the pose data is configured to control the virtual object to display the pose indicated by the pose data. The pose data and the expression data are sent to the first device. As such, the establishment of the virtual scene may be achieved through the interaction between the second device with the first device, and the virtual scene may be presented realistically through the pose data and the expression data, so that the virtual object in the virtual scene is more realistic, and it is conducive to improving the rendering efficiency and the rendering quality of the virtual object and/or virtual object. The head-mounted first device facilitates the user to free their hands and facilitate the immersive experience of the virtual scene, thus contributing to the improvement of the user experience.

In a possible example, in the aspect of generating the expression data based on the facial image, the program includes instructions for executing the following operations:
generating multiple facial key points based on the facial image;
dividing the multiple facial key points into multiple key point sets;
generating, based on the face key points, mesh information of the facial image;
determining, based on the mesh information and the multiple key point sets, multiple expression base coefficients of the user, where each of the multiple expression base coefficients corresponds to one expression base; and
generating the expression data, based on the multiple expression base coefficients, the mesh information and the expression bases, where the expression data is configured to drive a face of the virtual object to present an expression of the user.

In a possible example, the user includes multiple joint points, and in the aspect of generating the pose data of the user, the program includes instructions for executing the following operations:
receiving multiple mark signals from the multiple joint points, where each of the multiple joint points corresponds to one of the multiple mark signals;
calculating, based on the multiple mark signals, a distance from each of the multiple joint points to the second device, and obtaining multiple distances of the multiple joint points; and
generating the pose data of the user based on the multiple distances.

In a possible example, the program further includes instructions for executing the following operations:
acquiring an angular velocity, an acceleration, and a magnetic field direction detected by the second device;
determining, based on the angular velocity, the acceleration and the magnetic field direction, a degree of freedom of the second device, where the degree of freedom is configured to represent a change in rotation of a head and a change in displacement of a body of the virtual object; and
generating the pose data of the user, based on the degree of freedom and the multiple distances.

In a possible example, the program further includes instructions for executing the following operations:
obtaining an object location of a virtual item in the virtual scene and an anchor location of the virtual object in the virtual scene;
determining, based on the multiple distances and the anchor location, a current location of the user relative to the anchor location;
determining, based on the current location and the object location, whether the user triggers an interactive operation on the virtual item; and
in response to determining that the user triggers the interactive operation on the virtual item, controlling the virtual item to respond to the interactive operation.

The solutions of the embodiments of the disclosure are described above mainly from the perspective of the execution process on the method side. It may be understood that, to implement the foregoing functions, the electronic device includes a corresponding hardware structure and/or software module for implementing the various functions. It should be apparent to those skilled in the art that, with reference to the units and algorithm operations of the various examples described in the embodiments provided herein, the disclosure may be implemented by hardware or a combination of hardware and computer software. Whether a particular function is performed by hardware or hardware driven by computer software depends on particular applications and design constraints of the technical solutions. Those skilled in the art may use different methods to implement the described functions for each particular application, but it should not be considered that the implementation goes beyond the scope of embodiments of the disclosure.

In the embodiments of the disclosure, the electronic device may be divided into function units based on the foregoing method examples. For example, individual function units may be obtained through division based on individual functions, or two or more functions may be integrated into one processing unit. The integrated unit may be implemented as hardware, or a software functional unit. It is notable that, in the embodiments of the disclosure, the unit division is exemplary and is merely a logical function division. In practice, other division manners may be used.

In the case of dividing various functional modules corresponding to individual functions, FIG. 10A is a schematic diagram of an apparatus for device interaction in a virtual scene. As illustrated in FIG. 10A, the apparatus is implemented by a first device, and the first device establishes a communication connection with at least one second device. The apparatus for device interaction in the virtual scene 1000 may include: a creating unit 1001, a receiving unit 1002 and a determining unit 1003, where:
the creating unit 1001 is configured to create a virtual scene;
the receiving unit 1002 is configured to receive a virtual scene entry request sent by each of the at least one second device, and determine at least one of the at least one second device that enters the virtual scene, where the virtual scene entry request sent by each second device includes a virtual object corresponding to the second device;
the determining unit 1003 is configured to determine an anchor location for each virtual object in the virtual scene, and display the virtual object corresponding to each of the second device synchronously at the respective anchor location, where the anchor location is configured to determine a relative position of the virtual object in the virtual scene; and
the receiving unit 1002 is further configured to receive pose data and expression data sent by each of the at least one second device, and control the virtual object to display an expression indicated by the expression data and a pose indicated by the pose data.

It can be seen that, with regard to the apparatus for device interaction in the virtual scene described in the embodiments of the disclosure, the virtual scene is created; the virtual scene entry request sent by each of the at least one second device is received, and the at least one second device that enters the virtual scene is determined from the at least one second device, where the virtual scene entry request includes the virtual object corresponding to the second device; the anchor location is determined for each virtual object in the virtual scene, and the virtual object corresponding to each second device is displayed synchronously at the anchor location, where the anchor location is configured to determine the relative position of the virtual object in the virtual scene; the pose data and the expression data sent by each of the at least one second device is received, and the virtual object is controlled to display the expression indicated by the expression data and the pose indicated by the pose data. In this way, the establishment of the virtual scene may be achieved through an interaction between the first device with the at least one second device; and the virtual scene may be presented realistically through the pose data and the expression data, so that the virtual object in the virtual scene is more realistic, which is conducive to improving user experience. The location and orientation of the virtual object in the virtual scene are adjusted based on the anchor location, and there is no need for each electronic device to individually construct a map or perform pose recognition in real time. This reduces the dependence on visual algorithms and high-precision IMUs, facilitates faster adaptation of the user's pose, and is conducive to improving the rendering efficiency and the rendering quality of the virtual object. The head-mounted first device is conducive to freeing the user's hands, which helps to improve the user's experience.

In a possible example, FIG. 10B is a schematic diagram of an apparatus for device interaction in a virtual scene. Based on FIG. 10A, the apparatus for device interaction in the virtual scene 1000 may include: a detecting unit 1004, which is configured to:
in response to first pose data sent by any one of the at least one second device, determine a first virtual object corresponding to the first pose data, and determine, based on the first pose data and the anchor location of the first virtual object, a first current location of the first virtual object;
in response to second pose data sent by another second device in the at least one second device except the second device corresponding to the first virtual object, determine a second virtual object corresponding to the second pose data, and determine based on the second pose data and the anchor location of the second virtual object, a second current location of the second virtual object; and
detect, based on the first current location and the second current location, whether there is a risk of collision between the first virtual object and the second virtual object.

In a possible example, after detecting whether there is the risk of collision between the first virtual object and the second virtual object, the detecting unit 1004 is further configured to:
determine a to-be-collided point, in response to detecting the risk of collision between the virtual objects corresponding to any two of the second devices;
determine, based on the to-be-collided point, a first collision action and a second collision action of the any two virtual objects respectively, a first joint point for the first collision action, and a second joint point for the second collision action; and
determine, based on the first collision action and the second collision action, whether the second device corresponding to the first virtual object triggers an interactive operation on the first virtual object, and/or whether the second device corresponding to the second virtual object triggers an interactive operation on the second virtual object.

In a possible example, in the aspect of determining, based on the first collision action and the second collision action, whether the second device corresponding to the first virtual object triggers an interactive operation on the first virtual object, and/or whether the second device corresponding to the second virtual object triggers an interactive operation on the second virtual object, the detecting unit 1004 is specifically configured to:
in response to the first collision action and the second collision action being a same collision type, determine that the second device corresponding to the first virtual object triggers the interactive operation on the first virtual object, and/or the second device corresponding to the second virtual object triggers the interactive operation on the second virtual object;
determine a collision point and collision information at the collision point upon the collision between the first virtual object and the second virtual object, where the collision information includes a collision speed and a collision plane;
determine a first collision animation for the first joint point and a second collision animation for the second joint point;
adjust, based on the collision speed and the collision plane, a display location of the first collision animation and a display location of the second collision animation; and
send the adjusted display location of the first collision animation to the second device corresponding to the first virtual object, and send the adjusted display location of the second collision animation to the second device corresponding to the second virtual object.

In a possible example, in the aspect of detecting, based on the first current location and the second current location, whether there is a risk of collision between the first virtual object and the second virtual object, the detecting unit 1004 is specifically configured to:
determine, based on the first current location, a first target bounding box of the first virtual object, and determine, based on the second current location, a second target bounding box of the second virtual object;
in response to an intersection between the first target bounding box and the second target bounding box, determine an intersection range of the intersection; and
detect, based on the intersection range, whether there is the risk of collision between the first virtual object and the second virtual object.

In a possible example, in the aspect of determining, based on the first current location, the first target bounding box of the first virtual object and determining, based on the second current location, the second target bounding box of the second virtual object, the determining unit 1003 is further configured to:
construct, based on the first current location and the second current location, a same three-dimensional coordinate system, and constructing the first bounding box of the first virtual object and the second bounding box of the second virtual object in the three-dimensional coordinate system, where the first bounding box includes a first center and multiple first vertices, and the second bounding box includes a second center and multiple second vertices;
obtain a first target bounding box, by correcting the first bounding box with the multiple first vertices of the first bounding box traversed; and
obtain a second target bounding box, by correcting the second bounding box with the multiple second vertices of the second bounding box traversed.

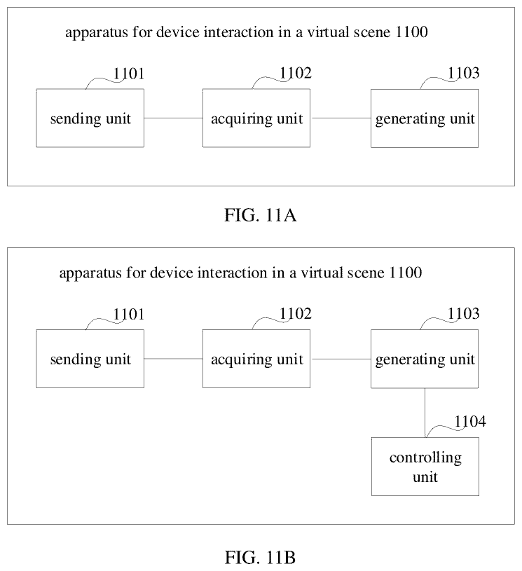

FIG. 11A is a schematic diagram of an apparatus for device interaction in a virtual scene. As illustrated in FIG. 11A, the apparatus is implemented by a second device, the second device is worn on a user and is in a communication connection with the first device, and the apparatus for device interaction in the virtual scene 1100 includes a sending unit 1101, an acquiring unit 1102 and a generating unit 1103, where:
the sending unit 1101 is configured to send a virtual scene entry request to the first device, where the virtual scene entry request includes a virtual object;
the acquiring unit 1102 is configured to acquire a facial image of the user;
the generating unit 1103 is configured to generate expression data based on the facial image, where the expression data is configured to control the virtual object to display an expression indicated by the expression data;
the generating unit 1103 is further configured to generate pose data of the user, where the pose data is configured to control the virtual object to display a pose indicated by the pose data; and
the sending unit 1101 is further configured to send the pose data and the expression data to the first device.

As can be seen that, for the apparatus for device interaction in the virtual scene described in the embodiments of the disclosure, the virtual scene entry request is sent to the first device, where the virtual scene entry request includes the virtual object. The facial image of the user is acquired, and the expression data is generated based on the facial image, where the expression data is configured to control the virtual object to display the expression indicated by the expression data. The pose data of the user is generated, where the pose data is configured to control the virtual object to display the pose indicated by the pose data. The pose data and the expression data are sent to the first device. As such, the establishment of the virtual scene may be achieved through the interaction between the second device with the first device, and the virtual scene may be presented realistically through the pose data and the expression data, so that the virtual object in the virtual scene is more realistic, and it is conducive to improving the rendering efficiency and the rendering quality of the virtual object and/or virtual object. The head-mounted first device facilitates the user to free their hands and facilitate the immersive experience of the virtual scene, thus contributing to the improvement of the user experience.

In a possible example, in the aspect of generating the expression data based on the facial image, the generating unit 1103 is specifically configured to:
generate multiple facial key points based on the facial image;
divide the multiple facial key points into multiple key point sets;
generate, based on the face key points, mesh information of the facial image;
determine, based on the mesh information and the multiple key point sets, multiple expression base coefficients of the user, where each of the multiple expression base coefficients corresponds to one expression base; and
generate the expression data, based on the multiple expression base coefficients, the mesh information and the expression bases, where the expression data is configured to drive a face of the virtual object to present an expression of the user.

In a possible example, the user includes multiple joint points, and in the aspect of generating the pose data of the user, the generating unit 1103 is specifically configured to:
receive multiple mark signals from the multiple joint points, where each of the multiple joint points corresponds to one of the multiple mark signals;
calculate, based on the multiple mark signals, a distance from each of the multiple joint points to the second device, and obtain multiple distances of the multiple joint points; and
generate the pose data of the user based on the multiple distances.

In a possible example, the program further includes instructions for executing the following operations:
acquiring an angular velocity, an acceleration, and a magnetic field direction detected by the second device;
determining, based on the angular velocity, the acceleration and the magnetic field direction, a degree of freedom of the second device, where the degree of freedom is configured to represent a change in rotation of a head and a change in displacement of a body of the virtual object; and
generating the pose data of the user, based on the degree of freedom and the multiple distances.

In a possible example, corresponding to FIG. 11A, as illustrated in FIG. 11B, an apparatus for device interaction in a virtual scene 1100 may include: a controlling unit 1104, which is configured to:
obtain an object location of a virtual item in the virtual scene and an anchor location of the virtual object in the virtual scene;
determine, based on the multiple distances and the anchor location, a current location of the user relative to the anchor location;
determine, based on the current location and the object location, whether the user triggers an interactive operation on the virtual item; and
in response to determining that the user triggers the interactive operation on the virtual item, control the virtual item to respond to the interactive operation.

It should be noted that, all related content of the operations in the foregoing method embodiments may be referenced to function descriptions of corresponding functional modules, and details are not described herein again.

The electronic device provided in the embodiments is configured to execute the foregoing method for device interaction in the virtual scene, and therefore can achieve the same effect as implementing the foregoing method.

When an integrated unit is used, the electronic device may include a processing module, a storage module, and a communication module. The processing module may be configured to control and manage an action of the electronic device, for example, may be configured to support the electronic device in performing steps performed by the creating unit 1001, the receiving unit 1002 and the determining unit 1003, and the detecting unit 1004 described above, as well as by the transmitting unit 1101, the acquiring unit 1102, the generating unit 1103, and the controlling unit 1104. The storage module may be configured to support the electronic device in executing storage program code, data, and the like. The communication module may be configured to support communication between the electronic device and other devices.

The processing module may be a processor or a controller. The processing module may implement or execute various example logical blocks, modules, and circuits described with reference to the content disclosed in the disclosure. The processor may also be a combination of implementing a computing function, for example, a combination of one or more microprocessors, a combination of a digital signal processing (DSP) and a microprocessor. The storage module may be a memory. The communication module may specifically be a device that interacts with other electronic devices, for example, the communication module may be a radio frequency circuit, a Bluetooth chip, or a Wi-Fi chip.

Embodiments of the disclosure further provide a computer storage medium. The computer storage medium stores a computer program for electronic data exchange, and the computer program causes a computer to perform part or all steps of any method as described in the above method embodiments. The computer includes an electronic device.

Embodiment of the disclosure further provides a computer program product. The computer program product includes a non-transitory computer-readable storage medium having a computer program stored therein, which is operable to cause a computer to perform part or all of the operations of any method as described in the above method embodiments. The computer program product may be a software installation package, and the computer includes an electronic device.

It should be noted that, for brief description, the foregoing method embodiments are all expressed as a series of actions. However, those skilled in the art should appreciate that the disclosure is not limited to the described order of the actions, because according to the disclosure, some operations may be performed in other orders or simultaneously. In addition, those skilled in the art should further know that the embodiments described in the specification are all example embodiments, and the related actions and modules are not necessarily required by the disclosure.

In the embodiments, the description of each embodiment has its own emphasis. For the parts not described in detail in a certain embodiment, reference may be made to related descriptions in other embodiments.

In the embodiments provided in the disclosure, it will be appreciated that the apparatuses disclosed herein may also be implemented in various other manners. For example, the above apparatus embodiments are merely illustrative, e.g., the division of units is only a division of logical functions, and there may exist other manners of division in practice, e.g., multiple units or assemblies may be combined or may be integrated into another system, or some features may be ignored or not implemented. In other aspects, the coupling or direct coupling or communication connection as illustrated or discussed herein may be an indirect coupling or communication connection through some interfaces, apparatuses, or units, and may be electrical, or otherwise.

The units illustrated as separated components may or may not be physically separated. Components or parts displayed as units may or may not be physical units, and may be in the same place or may be distributed to multiple network units. Some or all of the units may be selectively adopted according to practical needs to achieve desired objectives of the solutions in the embodiments.

In addition, the various functional units described in various embodiments of the disclosure may be integrated into one processing unit or may be present as a number of physically separated units, and two or more units may be integrated into one unit. The integrated unit may be implemented by hardware or a software functional unit.

When the integrated units are implemented as software functional units and sold or used as standalone products, the integrated units may be stored in a computer readable storage medium. Based on such understanding, the technical solution of the disclosure in essence, or the portion that contributes to the prior art, or all or part of the technical solution may be embodied as software products. The computer software products may be stored in a memory and may include multiple instructions which, when being executed, may cause a computer device (e.g., a personal computer, a server, a network device, etc.) to execute all or part of the operations of the methods described in various embodiments of the disclosure. The above memory may include various kinds of media that can store program codes, such as a universal serial bus (USB) flash disk, a read-only memory (ROM), a random access memory (RAM), a mobile hard drive, a magnetic disk, or an optical disk.

It will be understood by those of ordinary skill in the art that all or a part of the various methods of the embodiments described above may be accomplished by means of a program to instruct associated hardware, and the program may be stored in a computer-readable memory, which may include a flash disk, an ROM, an RAM, a magnetic disk, or an optical disk.

The above embodiments in the disclosure are described in detail. Principles and implementations of the disclosure are elaborated with specific examples herein. The illustration of the above embodiments is only used to help understanding of methods and core ideas of the disclosure. For those of ordinary skill in the art, according to ideas of the disclosure, there may be modifications in the specific embodiments and in the application scopes of the disclosure. In summary, the contents of the specification should not be construed as limitations of the disclosure.

What is claimed is:

1. A method for device interaction in a virtual scene, wherein the method is implemented by a first device, the first device is in a communication connection with at least one second device, and the method comprises:
creating a virtual scene;
receiving a virtual scene entry request sent by each of the at least one second device, and determining, based on the virtual scene entry request, a virtual object corresponding to each of the at least one second device that enters the virtual scene, wherein the virtual scene entry request sent by each second device comprises the virtual object corresponding to the second device;
determining an anchor location for each virtual object in the virtual scene, and displaying the virtual object corresponding to each of the at least one second device at the respective anchor location, wherein the anchor location for each virtual object is configured to determine a relative position of the virtual object in the virtual scene; and
receiving pose data and expression data sent by each of the at least one second device, and controlling the virtual object to display an expression indicated by the expression data and a pose indicated by the pose data.

2. The method as claimed in claim 1, wherein the at least one second device that enters the virtual scene comprises at least two second devices, and the method further comprises:
in response to first pose data sent by any one of the at least two second devices, determining a first virtual object corresponding to the first pose data, and determining, based on the first pose data and the anchor location of the first virtual object, a first current location of the first virtual object;
in response to second pose data sent by another second device in the at least two second devices except the second device corresponding to the first virtual object, determining a second virtual object corresponding to the second pose data, and determining, based on the second pose data and the anchor location of the second virtual object, a second current location of the second virtual object; and
detecting, based on the first current location and the second current location, whether there is a risk of collision between the first virtual object and the second virtual object.

3. The method as claimed in claim 2, wherein after detecting whether there is the risk of collision between the first virtual object and the second virtual object, the method further comprises:
determining a to-be-collided point, in response to detecting the risk of collision between the virtual objects corresponding to any two of the at least two second devices;
determining, based on the to-be-collided point, a first collision action and a second collision action of the virtual objects of the any two second devices respectively, a first joint point for the first collision action, and a second joint point for the second collision action; and
determining, based on the first collision action and the second collision action, whether the second device corresponding to the first virtual object triggers an interactive operation on the first virtual object, and/or whether the second device corresponding to the second virtual object triggers an interactive operation on the second virtual object.

4. The method as claimed in claim 3, wherein determining, based on the first collision action and the second collision action, whether the second device corresponding to the first virtual object triggers the interactive operation on the first virtual object, and/or whether the second device corresponding to the second virtual object triggers the interactive operation on the second virtual object, comprises:
in response to the first collision action and the second collision action being a same collision type, determining that the second device corresponding to the first virtual object triggers the interactive operation on the first virtual object, and/or the second device corresponding to the second virtual object triggers the interactive operation on the second virtual object;
determining a collision point and collision information at the collision point upon the collision between the first virtual object and the second virtual object, wherein the collision information comprises a collision speed and a collision plane;
determining a first collision animation for the first joint point and a second collision animation for the second joint point;
adjusting, based on the collision speed and the collision plane, a display location of the first collision animation and a display location of the second collision animation; and
sending the adjusted display location of the first collision animation to the second device corresponding to the first virtual object, and sending the adjusted display location of the second collision animation to the second device corresponding to the second virtual object.

5. The method as claimed in claim 4, wherein adjusting, based on the collision speed and the collision plane, the display location of the first collision animation and the display location of the second collision animation, comprises:
adjusting, by adjusting the display location of the first collision animation and the display location of the second collision animation, the first collision animation of the first joint point for the first collision action and the second collision animation of the second joint point for the second collision action to be in a same collision plane; and
adjusting, based on the collision speed, a playback frequency and a playback speed of the first collision animation and a playback frequency and a playback speed of the second collision animation; and
wherein the method further comprises:
sending the adjusted playback frequency and the adjusted playback speed of the first collision animation to the second device corresponding to the first virtual object, and sending the adjusted playback frequency and the adjusted playback speed of the second collision animation to the second device corresponding to the second virtual object.

6. The method as claimed in claim 2, wherein detecting, based on the first current location and the second current location, whether there is the risk of collision between the first virtual object and the second virtual object, comprises:
determining, based on the first current location, a first target bounding box of the first virtual object, and determining, based on the second current location, a second target bounding box of the second virtual object;
in response to an intersection between the first target bounding box and the second target bounding box, determining an intersection range of the intersection; and
detecting, based on the intersection range, whether there is the risk of collision between the first virtual object and the second virtual object.

7. The method as claimed in claim 6, wherein the detecting, based on the intersection range, whether there is the risk of collision between the first virtual object and the second virtual object comprises:
in response the intersection range being greater than or equal to a preset threshold, determining that there is the risk of collision between the first virtual object and the second virtual object; and
in response to the intersection range being less than the preset threshold, determining that there is no risk of collision between the first virtual object and the second virtual object.

8. The method as claimed in claim 7, wherein after determining that there is the risk of collision between the first virtual object and the second virtual object in response the intersection range being greater than or equal to the preset threshold, the method further comprises:
in response to determining that there is no interaction operation between the first virtual object and the second virtual object, increasing a distance between the first virtual object and the second virtual object.

9. The method as claimed in claim 6, wherein determining, based on the first current location, the first target bounding box of the first virtual object and determining, based on the second current location, the second target bounding box of the second virtual object, comprises:
constructing, based on the first current location and the second current location, a same three-dimensional coordinate system, and constructing the first bounding box of the first virtual object and the second bounding box of the second virtual object in the three-dimensional coordinate system, wherein the first bounding box comprises a first center and a plurality of first vertices, and the second bounding box comprises a second center and a plurality of second vertices;
obtaining a first target bounding box, by correcting the first bounding box with the plurality of first vertices of the first bounding box traversed; and
obtaining a second target bounding box, by correcting the second bounding box with the plurality of second vertices of the second bounding box traversed.

10. The method as claimed in claim 2, wherein the pose data comprises a distance from a joint point of a user corresponding to the second device, and the method further comprises:
establishing a coordinate system based on the anchor location of the first virtual object and the anchor location of the second virtual object;
wherein determining, based on the first pose data and the anchor location of the first virtual object, the first current location of the first virtual object, comprises:
determining, based on the anchor location of the first virtual object and the distance in the first pose data, a first relative position of the first virtual object with respect to the anchor location of the first virtual object; and
obtaining the first current location of the first virtual object by transforming coordinates of the first relative position based on the coordinate system; and
wherein determining, based on the second pose data and the anchor location of the second virtual object, the second current location of the second virtual object, comprises:
determining, based on the anchor location of the second virtual object and the distance in the second pose data, a second relative position of the second virtual object with respect to the anchor location of the second virtual object; and
obtaining the second current location of the second virtual object by transforming coordinates of the second relative position based on the coordinate system.

11. A method for device interaction in a virtual scene, wherein the method is implemented by a second device, the second device is worn on a head of a user and is in a communication connection with a first device, and the method comprises:
sending a virtual scene entry request to the first device, wherein the virtual scene entry request comprises a virtual object;
acquiring a facial image of the user;
generating expression data based on the facial image, wherein the expression data is configured to control the virtual object to display an expression indicated by the expression data;
generating pose data of the user, wherein the pose data is configured to control the virtual object to display a pose indicated by the pose data; and
sending the pose data and the expression data to the first device.

12. The method as claimed in claim 11, wherein generating the expression data based on the facial image, comprises:
generating a plurality of facial key points based on the facial image;
dividing the plurality of facial key points into a plurality of key point sets;
generating, based on the face key points, mesh information of the facial image;
determining, based on the mesh information and the plurality of key point sets, a plurality of expression base coefficients of the user, wherein each of the plurality of expression base coefficients corresponds to one expression base; and
generating the expression data, based on the plurality of expression base coefficients, the mesh information and the expression bases, wherein the expression data is configured to drive a face of the virtual object to present an expression of the user.

13. The method as claimed in claim 11, wherein the user comprises a plurality of joint points, and generating the pose data of the user, comprises:
receiving a plurality of mark signals from the plurality of joint points, wherein each of the in plurality of joint points corresponds to one of the plurality of mark signals;
calculating, based on the plurality of mark signals, a distance from each of the plurality of joint points to the second device, and obtaining a plurality of distances of the plurality of joint points; and
generating the pose data of the user based on the plurality of distances.

14. The method as claimed in claim 13, wherein generating the pose data of the user based on the plurality of distances, comprises:
acquiring an angular velocity, an acceleration, and a magnetic field direction detected by the second device;
determining, based on the angular velocity, the acceleration and the magnetic field direction, a degree of freedom of the second device, wherein the degree of freedom is configured to represent a change in rotation of a head and a change in displacement of a body of the virtual object; and
generating the pose data of the user, based on the degree of freedom and the plurality of distances.

15. The method as claimed in claim 13, further comprising:
obtaining an object location of a virtual item in the virtual scene and an anchor location of the virtual object in the virtual scene;
determining, based on the plurality of distances and the anchor location, a current location of the virtual object corresponding to the user relative to the anchor location;
determining, based on the current location and the object location, whether the user triggers an interactive operation on the virtual item; and
in response to determining that the user triggers the interactive operation on the virtual item, controlling the virtual item to respond to the interactive operation.

16. An electronic device, comprising a processor, a memory, a communication interface, and one or more programs, wherein the one or more programs are stored in the memory and configured to be executed by the processor, and the one or more programs comprise instructions for executing operations in a method for device interaction in a virtual scene, comprising:
creating a virtual scene;
receiving a virtual scene entry request sent by at least one second device, determining, as a target second device, each second device that enters the virtual scene, and acquiring a virtual object corresponding to each target second device from the virtual scene entry request sent by the target second device;
determining an anchor location for each virtual object in the virtual scene, and displaying the virtual object corresponding to each target second device at the respective anchor location, wherein the anchor location for each virtual object is configured to determine a relative position of the virtual object in the virtual scene; and
receiving pose data and expression data sent by each target second device, and controlling the virtual object corresponding to the target second device to display an expression indicated by the expression data and a pose indicated by the pose data.

17. The electronic device as claimed in claim 16, wherein there are at least one target second devices, and the method further comprises:
in response to first pose data sent by any one of the at least two target second devices, determining a first virtual object corresponding to the first pose data, and determining, based on the first pose data and the anchor location of the first virtual object, a first current location of the first virtual object;
in response to second pose data sent by another target second device in the at least two target second devices except the target second device corresponding to the first virtual object, determining a second virtual object corresponding to the second pose data, and determining, based on the second pose data and the anchor location of the second virtual object, a second current location of the second virtual object; and
detecting, based on the first current location and the second current location, whether there is a risk of collision between the first virtual object and the second virtual object.

18. The electronic device as claimed in claim 17, wherein after detecting whether there is the risk of collision between the first virtual object and the second virtual object, the method further comprises:
determining a to-be-collided point, in response to detecting the risk of collision between the first virtual object and the second virtual object;
determining, based on the to-be-collided point, a first collision action of the first virtual object and a second collision action of the second virtual object, a first joint point for the first collision action, and a second joint point for the second collision action; and
determining, based on the first collision action and the second collision action, whether the target second device corresponding to the first virtual object triggers an interactive operation on the first virtual object, and/or whether the target second device corresponding to the second virtual object triggers an interactive operation on the second virtual object.

19. The electronic device as claimed in claim 18, wherein determining, based on the first collision action and the second collision action, whether the target second device corresponding to the first virtual object triggers the interactive operation on the first virtual object, and/or whether the target second device corresponding to the second virtual object triggers the interactive operation on the second virtual object, comprises:
in response to the first collision action and the second collision action being a same collision type, determining that the target second device corresponding to the first virtual object triggers the interactive operation on the first virtual object, and/or the target second device corresponding to the second virtual object triggers the interactive operation on the second virtual object;
determining a collision point and collision information at the collision point upon the collision between the first virtual object and the second virtual object, wherein the collision information comprises a collision speed and a collision plane;
determining a first collision animation for the first joint point and a second collision animation for the second joint point;
adjusting, based on the collision speed and the collision plane, a display location of the first collision animation and a display location of the second collision animation; and
sending the adjusted display location of the first collision animation to the target second device corresponding to the first virtual object, and sending the adjusted display location of the second collision animation to the target second device corresponding to the second virtual object.

20. The electronic device as claimed in claim 17, wherein detecting, based on the first current location and the second current location, whether there is the risk of collision between the first virtual object and the second virtual object, comprises:
determining, based on the first current location, a first target bounding box of the first virtual object, and determining, based on the second current location, a second target bounding box of the second virtual object;
in response to an intersection between the first target bounding box and the second target bounding box, determining an intersection range of the intersection; and
detecting, based on the intersection range, whether there is the risk of collision between the first virtual object and the second virtual object.
